(19) United States
(12) Patent Application Publication
(10) Pub. No.: US 2008/0038547 A1
(43) Pub. Date: Feb. 14, 2008

(54) FLAT FILM BARRIER FOR PACKAGING MATERIAL

(75) Inventor: Ann Marie Kenback Ash, Brooklyn Park, MN (US)

Correspondence Address: TETRA PAK US INTELLECTUAL PROPERTY DEPARTMENT;TETRA PAK INC., 101 COPORATE WOODS PARKWAY, VERNON HILLS, IL, 60061, US

(73) Assignee: TETRA LAVAL HOLDINGS & FINANCE, S.A., Pully (CH)

(21) Appl. No.: 11/463,132

(22) Filed: Aug. 8, 2006

(51) Int. Cl. B32B 27/34; B32B 27/10; B32B 27/32; B32B 27/08

(52) U.S. Cl. 428/342; 428/537.5; 428/513; 428/523; 428/474.4; 428/475.5

(57) ABSTRACT

A flat film barrier laminate material for food packaging includes a core layer of paper or paperboard having a first side and a second side, a polymeric coating applied to the first side of the core layer and a food contacting layer disposed on the second side of the core layer. The food contacting barrier layer is formed from a plurality of series of layers of polymeric materials. Each series of layers includes a polyolefin layer, a tie layer, a polyamide resin layer, a tie layer and a polyolefin layer. The plurality is a whole number greater than one and the layers are applied to provide a weight ratio of materials in each series of 15:50 for the polyolefin layers, 5:50 for the tie layers and 10:50 for the polyamide resin layer.

### BACKGROUND OF THE INVENTION

The present invention relates to a barrier material for packaging. More particularly, the present invention relates to a flat film barrier material for packaging that provides enhanced barrier properties in a flat film for package material.

Laminated materials are common and in wide-spread use in liquid food packaging. A typical laminated material is formed from a relatively rigid but foldable paper or paperboard core layer onto which one or more liquid tight coatings of plastic are applied. These laminates provide good mechanical configurational stability and are relatively low in cost.

In an effort to reduce oxygen permeation, which is problematic for foods that have shelf life, flavor and/or nutrient contents that can dramatically deteriorate in contact with oxygen, barrier layers of gas impermeable materials are provided on that side of the core layer that is on the inner surface of the package (toward the stored product). Experience has shown that superior oxygen impermeability is provided by materials such as aluminum foil, ethylene vinyl alcohol (EVOH), nylon, polyvinylidene chloride (PVDC) and polyvinyl alcohol (PVOH).

Although these materials provide benefits and advantages over previously known non-barrier containing packages, they each have their drawbacks. For example, although aluminum foil provides quite acceptable oxygen barrier characteristics, materials that include aluminum foil cannot be easily recycled and can have severe environmental impact. As such, many aluminum foil based materials have been dismissed for use in single-use food packaging.

EVOH and PVOH are highly sensitive to moisture and rapidly lose their barrier characteristics against oxygen gas when they are exposed to a damp environment. Thus, these materials alone are unacceptable for liquid food packaging use when, for example, the packages may be required to have an extended shelf life.

Another problem with packaging materials is referred to as “scalping” in which the flavor from the packaged product is drawn into the package material. This is particularly problematic with LDPE which draws flavors and essential oils (such as the citrus oil d-limonene) from the packaged product into the polyethylene layer. In order to counter the scalping effect of LDPE (which is in contact with the food product) nylon is used as a barrier after a first LDPE layer to prevent the further migration of D-limonene beyond the first LDPE layer. A tie layer is typically used between the LDPE and the nylon to assure good adhesion between the layers.

Although nylon functions well as a barrier to reduce and/or eliminate scalping, because of the characteristic properties of nylon having stretch and memory set when heat processed, extrusion coating of nylon can result in machine direction curl. Moreover, extrusion coating of nylon in a one sided layer structure (such as LDPE/paperboard/nylon/tie/LDPE) results in uneven stress layer distribution. This tension can increase compression stress and thus require semi-material decurling in order to flatten the sheet for the converting process and subsequent printing and sealing.

In addition, this situation may require the semi-material to be flexed in the opposite direction (e.g., opposite of the curling) to roll winding. This increases the risk for décor side surface wrinkling.

In converting for gable top cartons, the machine direction of the package is oriented across the panels (horizontally). As such, the nylon memory (and thus curling) falls in line with the tendency of the material to round in the direction of carton bulging.

Accordingly, there is a need for a laminate packaging material that has a reduced tendency to curl. Desirably, such a material maintains high barrier characteristics, using for example nylon as a scalping barrier. More desirably, such a material uses no more quantities per unit of packaging material (e.g., material weight) to manufacture an equivalent square meter (or foot) of the packaging material).

### BRIEF SUMMARY OF THE INVENTION

A flat film barrier laminate material for food packaging has a reduced tendency to curl. Such a material maintains high barrier characteristics, using for example nylon as a scalping barrier, while at the same time reducing the bulge that can occur in such packages. The material uses no more quantities per unit of packaging material (e.g., material weight) to manufacture an equivalent square meter (or foot) of the packaging material as compared to conventional packaging materials.

The material is formed from a core layer of paper or paperboard having a first side and a second side. A polymeric coating is applied to the first side of the core layer. A food contacting layer is disposed on the second side of the core layer. The food contacting barrier is formed from a plurality of series of layers of polymeric materials.

In one embodiment each series of layers include a polyolefin layer, a tie layer, a polyamide resin layer, a tie layer and a polyolefin layer. In this embodiment, the plurality is a whole number greater than one and the layers are applied to provide a weight ratio of materials in each series of 15:50 for the polyolefin layers, 5:50 for the tie layers and 10:50 for the polyamide resin layer.

The polyolefin layer can be formed from low density polyethylene (LDPE), medium density polyethylene (MDPE), linear low density polyethylene (LLDPE), metallocene-based linear low density polyethylene (m-LLDPE), and blends thereof. The preferred polyolefin layer is LDPE. A preferred polyamide resin layer is a nylon layer, most preferably MXD6.

The tie layer can be a modified polyolefin, such as an anhydride modified polyolefin, and preferably a maleic anhydride modified polyethylene. The polymer coating applied to the first side of the core layer can be, for example, low density polyethylene (LDPE), linear low density polyethylene (LLDPE), medium density polyethylene (MDPE), metallocene-based linear low density polyethylene (m-LLDPE), and blends thereof.

An alternate laminate configuration includes a food contacting barrier layer that is formed from a plurality of series of layers of polymeric materials, each series of layers including a polyamide resin layer, a tie layer, a polyolefin layer and a tie layer. In this configuration, the plurality is a whole number greater than one and the layers are applied to provide a weight ratio of materials in each series of 15:31 for the polyolefin layer, 10:31 for the tie layers and 6:31 for the polyamide layer. The materials are preferably the same as that for the first embodiment.

In either embodiment, the number of series is preferably four or greater. Most preferably, the number of series is four or a geometric progression of four. In a present laminate, each of the series of layers is identical to each of the other series of layers. A carton formed from the flat film laminate is also disclosed.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of a typical gable top carton formed from a laminate material embodying the principles of the present invention, the carton being illustrated with a spout-type closure mounted thereto;

FIG. 2 is a cross-sectional illustration of an embodiment of a flat film barrier laminate material embodying the principles of the present invention;

FIG. 3 is a cross-sectional illustration of an alternate embodiment of the flat film barrier laminate material of the present invention;

FIG. 4 is a cross-sectional illustration of an alternate embodiment of the flat film barrier laminate material of the present invention; and

FIG. 5 is a schematic illustration of a multiplier or microlayer insert configuration for an extruder.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

It should be further understood that the title of this section of this specification, namely, “Detailed Description Of The Invention”, relates to a requirement of the United States Patent Office, and does not imply, nor should be inferred to limit the subject matter disclosed herein.

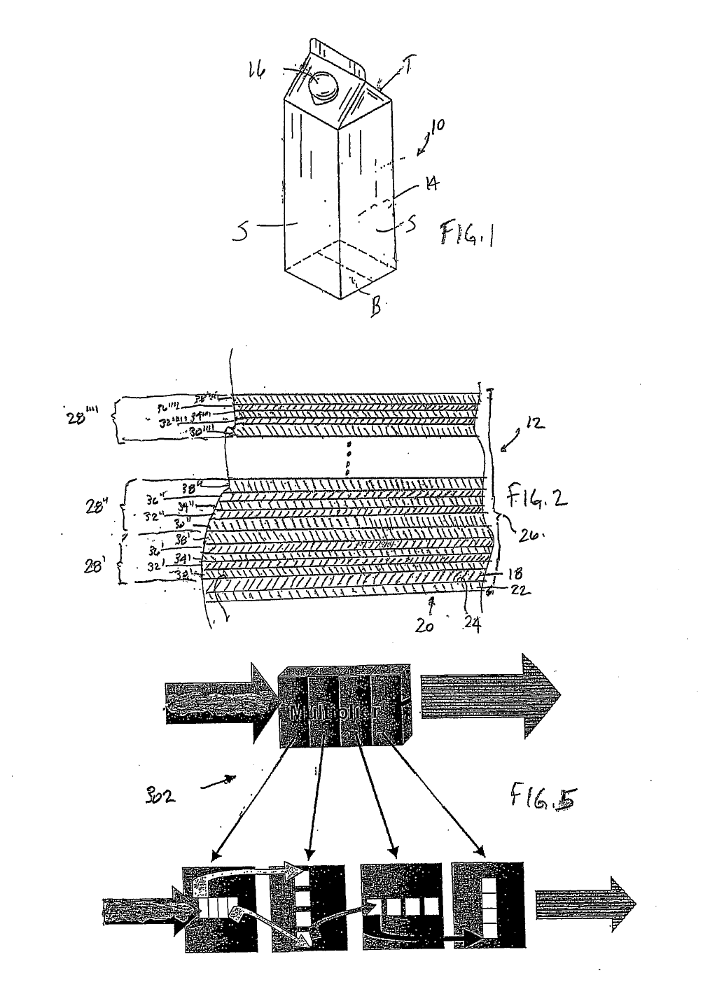

Referring now to the figures and in particular to FIG. 1, there is shown a carton 10 that is formed from a laminated material 12 embodying the principles of the present invention. The illustrated carton 10 is a standard gable top carton and includes four upstanding side walls S (two shown), a sealed bottom wall B (shown in phantom) and a gable top T. It will be appreciated that the present material 12 can be used for the manufacture of most any type of carton, and is not limited to use for gable top cartons.

The carton 10 defines an interior region, indicated generally at 14 in which product is stored, and is illustrated with a closure 16, such as the exemplary spout type closure that will be recognized by those skilled in the art. The spout closure 16 provides excellent resealability, while maintaining the carton 10 closed to prevent the ingress of oxygen into the carton 10 from the dispensing opening.

The laminated material 12 includes a base or core layer 18 of paper or paperboard material. Paper and paperboard materials and their methods of manufacture and use will be recognized by those skilled in the art.

From the core layer 18 to the outside of the carton indicated generally at 20, the material 12 includes a layer of a moisture-resistant polymeric material 22 disposed on an outer surface 24 of the core layer 18. The material 22 is typically a non-polar polymeric material. Presently, one material that is used is LDPE. LDPE is used because of its high-moisture barrier characteristics, relatively low cost and ease of use. LDPE is also approved for use in both food contacting and non-food contacting surfaces for food packaging materials. Also acceptable are linear low density polyethylene (LLDPE) and metallocene-based linear low density polyethylene (m-LLDPE), and blends of these materials.

Referring to FIG. 2, the inner, food contacting layer is a novel, micro-structured composite 26. The composite 26 includes repeating multiples of a layered structure or series 28. The structure 28 is a repeating application of a polyolefin layer 30, a tie layer 32, a polyamide resin layer 34, a tie layer 36, and a polyolefin layer 38.

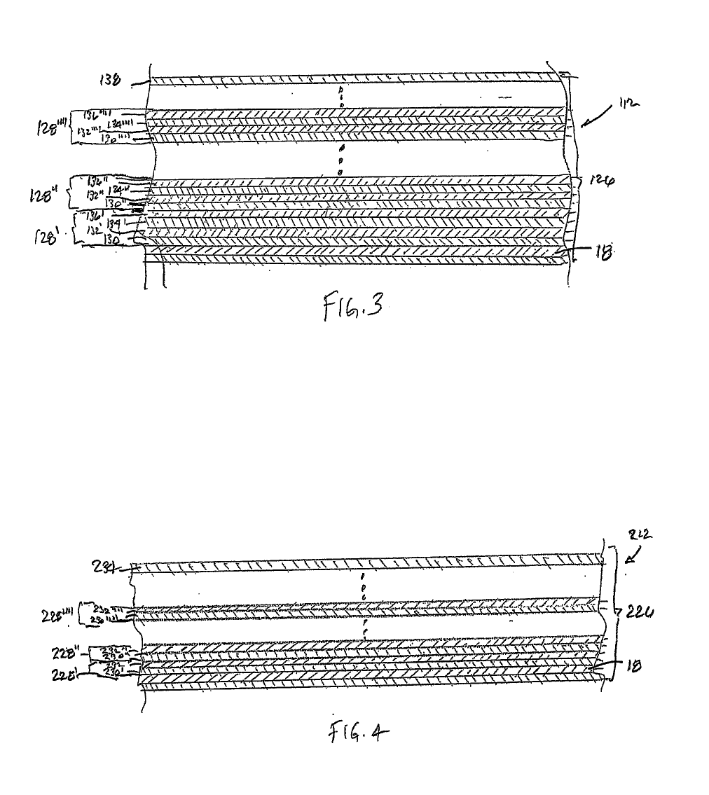

Alternately, as seen in FIG. 3, the structure 126 can be formed as a series 128 of a polyamide resin layer 130, a tie layer 132, a polyolefin layer 134 and a tie layer 136. In both structures, a tie layer 32, 36 and 132, 136 is present between the polyolefin layer 30, 38 and 134 and the polyamide resin layers 34 and 130.

In a present structure, the polyolefin layer or layer 30, 38 and 134 is or are LDPE layer(s) and the polyamide resin layer 34 and 130 is a nylon layer. In a present composite, the LDPE layers 30, 38 and 134 are a grade 4001i resin, commercially available from Dow Chemical Co., of Midland, Mich. The tie layers 32, 36 and 132, 136 are an anhydride modified LDPE, such as BYNEL, Series 4288, commercially available from E.I. DuPont Company, of Wilmington, Del. The tie layers 32, 36 and 132, 136 serve as an adhesive between the LDPE layer(s) 30, 38 and 134 and the nylon 34 and 130. It will be understood that the LDPE layer(s) 30, 38 and 134 function as a moisture barrier and as a seal layer. The nylon layer 34 and 130 provides a barrier to scalping by the LDPE layer(s) 30, 38 and 134. The nylon layer 34 and 130 material (which is a polyamide resin) is commercially available as MXD6 6011 from Mitsubishi Chemical Corporation of Chesapeake, Va. Other nylon materials (such as PA6 and PA6,6, and blends thereof) and tie layer materials will be recognized by those skilled in the art.

Unlike known nylon-based materials which tend to curl, the present multilayered structure 26, 126 provides a flat film structure by “dividing” the material layers 30-38 and 130-136 into multiple thinner layers of a barrier 34 and 130 bounded by a seal layer. In the presently illustrated embodiments, these layers 34 and 130 are nylon (as the barrier) bounded by LDPE 30, 38 and 134 (as the seal layer), with a tie layer 32, 36 and 132, 136 between the nylon 34 and 130 and the LDPE 30, 38 and 134 to provide good adhesion between the layers.

It will be appreciated that extruding molten polymer through multiplier inserts divides the polymer streams into thinner layers rather than extruding individual layers of thicker densities. It has been observed that depositing and stacking of the polyamide layers 34 and 130 with an adhesive tie 32, 36 and 132, 136 or polyolefin 30, 38 and 134 layer redistributes the polyamide (nylon) stresses throughout the structure. As a polyolefin (or tie) does not have the curl tension (that the nylon does), the stacked composite 26, 126 retains a flat formation thereby relieving curl stress. This also provides improved dimensional stability to the laminate 12, 112 and in turn to the package 10. This is particularly so with packages 10 in which the nylon 34 and 130 memory falls in line with the tendency of the material 12, 112 to round in the direction of carton bulging.

The present method of dividing and stacking (serially dividing) the layered structure as it comes out of the extruder, provides a flat film barrier structure from a laminate 12, 112 that might otherwise exhibit undesirable curling characteristics. Barrier characteristics are retained by depositing the nylon 34, 130 in close proximity to the product, and flat film characteristics (i.e., reduced or eliminated curling) are provided by creating thin layers of nylon 34, 130 which in turn distributes the nylon stresses throughout the structure.

The structure 26, 126 (which includes a combination of a tie layer 32, 36 and 132, 136 between the polyolefin 30, 38 and 134 and the polyamide resin 34 and 130 layers) is applied in a repeating pattern or structure, rather than as a single set of layers to form the composite. In the embodiment of FIG. 2, the inside of the packaging material 12 is, when viewed in cross-section, paperboard 18, LDPE 30′, tie 32′, nylon 34′, tie 36′, LDPE 38′, LDPE 30″, tie 32″, nylon 34″, tie 36″, LDPE 38″, . . . , LDPE 30″″, tie 32″″, nylon 34″″, tie 36″″, LDPE 38″″, in a predetermined number n of repeating series. This can also be viewed as paperboard 18, (LDPE 30, tie 32, nylon 34, tie 36, LDPE 38)ₙ, wherein n is a whole number multiple. In a present material, the number of series n is a geometric progression of 4 (e.g., n=4, 8, 16, 32, . . . ).

Alternately, as seen in FIG. 3, the inside of the packaging material 112, when viewed in cross-section is, paperboard 18, nylon 130′, tie 132′, LDPE 134′, tie 136′, nylon 130″, tie 132″, LDPE 134″, tie 136″, . . . , nylon 130″″, tie 132″″, LDPE 134″″, tie 136″″, in a predetermined number n of repeating series 126. This can also be viewed as paperboard 18, (nylon 130, tie 132, LDPE 134, tie 136)ₙ, wherein n is a whole number multiple. In a present material, the number of series n is a geometric progression of 4 (e.g., n=4, 8, 16, 32, . . . ). It is anticipated that in this arrangement, a final seal layer 138 of LDPE will be applied over the last tie layer 136.

Alternately still, as seen in FIG. 4, the inside of the packaging material 212, when viewed in cross-section, is paperboard 18, nylon 230′, tie 232′, nylon 230″, tie 232″ . . . nylon 230″″, tie 232″″. This can also be viewed as paperboard 18, (nylon 230, tie 232)ₙ, wherein n is a whole number multiple. In a present material 212, the number of series n is a geometric progression of 4 (e.g., n=4, 8, 16, 32, . . . ). It is anticipated that in this arrangement, a final seal layer 234 of, for example, LDPE will be applied over the last tie layer 232.

It has been observed that these arrangements 12, 112, 212 function well in that the nylon layers are sufficiently “thin” to reduce or eliminate the stresses that could otherwise result in curling of the material. In addition, the tie layer between the nylon and LDPE layers provide for adhesion between the layers and the nylon 34, 130 and 230 is sufficiently close to the paperboard 18 (either separated by a thin layer of LDPE and tie, or directly in contact with the board) to maintain the desired barrier characteristics without any appreciable scalping (by the LDPE between the nylon and the board).

The series 28, 128, 228 are applied at a weight that, in the aggregate, is no more than the weight that a single series would be applied in a comparable known carton. In the material 12 illustrated in FIG. 2, the aggregate weights of the LDPE 30-tie 32-nylon 34-tie 36-LDPE 38 are 15-5-10-5-15 grams per square meter of material. In that these are aggregate amounts, if the number of series n is 4, then there are four series 28′-28″″, and each respective series has layers, 30′-38′, 30″-38″, 30′″-38′″ and 30″″-38″″, and each layer in each series has a weight of material of 15/4-5/4-10/4-5/4-15/4, respectively. Accordingly, each of the layers is also thinner.

Likewise in the material 112 illustrated in FIG. 3, the aggregate weights of the nylon 130-tie 132-LDPE 134-tie 136 are 6-5-15-5 grams per square meter of material. In that these are aggregate amounts, if the number of series n is 4, then there are four series 128′-128″″, and each respective series has layers, 130′-136′, 130″-136″, 130′″-136′″ and 130″″-136″″, and each layer in each series has a weight of material of 6/4-5/4-15/4-5/4. Accordingly, each of the layers is also thinner.

And, likewise in the material 212 illustrated in FIG. 4, the aggregate weights of the nylon 230-tie 232 are 10-30 grams per square meter of material. In that these are aggregate amounts, if the number of series n is 4, then there are four series 228′-228″″, and each respective series has layers, 230′-232′, 230″-232″, 230′″-232′″ and 230″″-232″″, and each layer in each series has a weight of material of 10/4-30/4. Accordingly, each of the layers is also thinner.

It is anticipated that these structures 26, 126, 226 will function well to retain a flat profile because of the thin profile of the nylon layers 34, 130 and 230 and will also reduce scalping (i.e., act as a barrier) in that nylon or only a thin layer of LDPE will be in contact with the product, and that the structure or material will.

In a typical material 12, 112, 212 manufacturing process, the various layers are extruded or coextruded onto the paperboard. In order to achieve the serial application or multiple series of, for example, LDPE 30, tie 32, nylon 34, tie 36 and LDPE 38, a flow multiplier or micro-layer insert (in the die neck) is used, such that the flow stream of each of the layers is divide d into the desired number or series. In this manner, if the number of series is 4, and the nylon is applied in the aggregate at weight of 6 gsm, then the nylon is divided into four streams of 6/4 or 1.5 gsm (equivalent). A schematic illustration of a multiplier or microlayer feedblock 302 is illustrated in FIG. 5. One example of such a multiplier is that available from Extrusion Dies Industries, of Chippewa Falls, Wis.

It has also been found that extruding thinner layers improves the overall strength of the material 12, 112, 212. In addition, it has been found that MXD6 (as the nylon layer 34, 130, 230), which is brittle in extrusion coating and is otherwise challenging to extrude alone, when extruded in thinner layers between the also thinner olefin 30, 38 and 134 and/or tie layers 32, 36 and 132, 136 and 232 tends to be more workable and shows improved converting performance.

It will be appreciated that although specific materials are disclosed for the various material layers, other suitable materials can be used in the present flat film barrier material 12, 112, 212. For example, suitable material grades for the barrier, nylon layer 34, 130, 230, can include PA6, PA66 and/or blends of semi-crystalline or amorphous grades of nylon. The tie layer 32, 36 and 132, 136 and 232 can be a maleic anhydride modified PLEXAR® resin (commercially available from Equistar Chemical Company of Houston, Tex., a maleic anhydride modified SURLYN® resin (commercially available from E.I. DuPont). Olefins other than LDPE can be used for the olefin layer 30, 38 and 134 for example, olefins having a density of about 0.0920-0.0924 will also likely be suitable.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A flat film barrier laminate material for food packaging comprising:
a core layer of paper or paperboard having a first side and a second side;
a polymeric coating applied to the first side of the core layer; and
a food contacting layer disposed on the second side of the core layer, the food contacting barrier layer formed from a plurality of series of layers of polymeric materials, each series of layers including a polyolefin layer, a tie layer, a polyamide resin layer, a tie layer and a polyolefin layer,
wherein the plurality is a whole number greater than one and wherein the layers are applied to provide a weight ratio of materials in each series of 15:50 for the polyolefin layers, 5:50 for the tie layers and 10:50 for the polyamide resin layer.

2. The flat film barrier laminate material in accordance with claim 1 wherein the polyolefin layer is one of low density polyethylene (LDPE), medium density polyethylene (MDPE), linear low density polyethylene (LLDPE), metallocene-based linear low density polyethylene (m-LLDPE), and blends thereof.

3. The flat film barrier laminate material in accordance with claim 2 wherein the polyolefin layer is LDPE

4. The flat film barrier laminate material in accordance with claim 1 wherein the polyamide resin layer is a nylon layer.

5. The flat film barrier laminate material in accordance with claim 4 wherein the nylon is nylon MXD6.

6. The flat film barrier laminate material in accordance with claim 1 wherein the number of series is four or greater.

7. The flat film barrier laminate material in accordance with claim 6 wherein the number of series is a geometric progression of four.

8. The flat film barrier laminate material in accordance with claim 1 wherein the total weight of the food contacting barrier layer is 50 grams per square meter of material formed.

9. The flat film barrier laminate material in accordance with claim 8 wherein the number of series is four or a geometric progression of four.

10. The flat film barrier laminate material in accordance with claim 1 wherein the tie layer is a modified polyolefin.

11. The flat film barrier laminate material in accordance with claim 10 wherein the modified polyolefin is an anhydride modified polyolefin.

12. The flat film barrier laminate material in accordance with claim 11 wherein the anhydride modified polyolefin is a maleic anhydride modified polyethylene.

13. The flat film barrier laminate material in accordance with claim 1 wherein the polymeric coating applied to the first side of the core layer is one of low density polyethylene (LDPE), linear low density polyethylene (LLDPE), medium density polyethylene (MDPE), metallocene-based linear low density polyethylene (m-LLDPE), and blends thereof.

14. The flat film barrier laminate material in accordance with claim 1 wherein each of the series of layers is identical to each of the other series of layers.

15. A flat film barrier laminate material for food packaging comprising:
a core layer of paper or paperboard having a first side and a second side;
a polymeric coating applied to the first side of the core layer; and
a food contacting barrier layer disposed on the second side of the core layer, the food contacting barrier layer formed from a plurality of series of layers of polymeric materials, each series of layers including a polyamide resin layer, a tie layer, a polyolefin layer and a tie layer,
wherein the plurality is a whole number greater than one and wherein the layers are applied to provide a weight ratio of materials in each series of 15:31 for the polyolefin layer, 10:31 for the tie layers and 6:31 for the polyamide layer.

16. The flat film barrier laminate material in accordance with claim 15 wherein the polyamide resin layer is a nylon layer.

17. The flat film barrier laminate material in accordance with claim 15 including a seal layer on an outermost tie layer.

18. The flat film barrier laminate material in accordance with claim 17 wherein the seal layer is a polyolefin.

19. The flat film barrier laminate in accordance with claim 15 wherein the polymeric coating applied to the first side of the core layer is one of low density polyethylene (LDPE), linear low density polyethylene (LLDPE), medium density polyethylene (MDPE), metallocene-based linear low density polyethylene (m-LLDPE), and blends thereof.

20. The flat film barrier laminate material in accordance with claim 15 wherein the number of series is four or a geometric progression of four.

21. The flat film barrier laminate material in accordance with claim 15 wherein the tie layer is an anhydride modified polyolefin.

22. The flat film barrier laminate material in accordance with claim 21 wherein the anhydride modified polyolefin is a maleic anhydride modified polyethylene.
